(19) United States
(12) Patent Application Publication
(10) Pub. No.: US 2026/0016584 A1
(43) Pub. Date: Jan. 15, 2026

(54) UWB TAG AND METHOD FOR DETERMINING A PRESENCE OF A LIVING OBJECT AND A MULTISTATIC RADAR SYSTEM

(71) Applicant: Lateration GmbH, Erding (DE)

(72) Inventors: Juri SIDORENKO, Erding (DE); Michael SCHOBER, Graz (AT)

(21) Appl. No.: 19/268,128

(22) Filed: Jul. 14, 2025

(30) Foreign Application Priority Data
Jul. 15, 2024 (DE) 10 2024 206 648.6

(51) Int. Cl. G01S 13/04; G01S 7/03

(52) U.S. Cl. CPC G01S 13/04; G01S 7/03

(57) ABSTRACT

UWB tag for determining a presence of a living object, wherein the UWB tag includes at least one UWB frontend transceiver, and the UWB tag is configured to transmit several pulses and to receive several associated reflected channel-impulse responses and to subsequently evaluate the same with respect to a change in the received associated reflected channel-impulse responses, wherein determining the change in the associated reflected channel-impulse responses indicates the presence of the living object.

### CROSS-REFERENCE TO RELATED APPLICATION

This application claims priority from German Patent Application No. DE 10 2024 206 648.6, which was filed on Jul. 15, 2024, and is incorporated herein in its entirety by reference.

The present invention concerns a UWB tag for determining a presence of a living object, a method for determining a presence of a living object by using at least one UWB tag, and a multistatic radar system.

### BACKGROUND OF THE INVENTION

Nowadays, if special units have to force entry into a house, it is common to blow up (or explode) the main door. FIG. 1 shows a classic scenario in which terrorists block a door. The special unit is located on the right side at a safe distance to the door and is ready to explode the explosive charge previously placed so as to then enter the house. However, on the left side, hostages are placed directly behind the door, who would be severely injured in case of an explosion. However, the special unit might not have any knowledge about the hostages, which in turn means that they would probably be blasted, and that there would be a risk with respect to injuries of the hostages. Ideally, the special unit would receive information as to the fact that hostages have been placed on the other side of the door, and stop the explosion and open the door in a different way, or select a different entry into the house.

Exploding the door may lead to injuries of human beings or animals on the other side of the door. In particular, if the door is blocked by terrorists, there is a large probability of hostages having been placed directly behind the doors. In such a scenario, blowing up the door would lead to severe injuries or death of the hostages.

Thus, a solution to safely decide whether a door or a wall can be blown up in order to be able to reach living objects behind the door or wall, etc., without injuring the living objects is needed.

Reference [1] discloses an article about the application of the Fourier transform on UWB signals so as to be able to see through walls and to be able to detect movements and respiration.

References [2], [3] and [4] are each links to a UWB GPR detector that may be used to detect people behind a wall, wherein the UWB GPR detector is very expensive and should be reused.

U.S. Pat. No. 7,999,722 B2 is a patent corresponding to reference [2]. U.S. Pat. No. 7,999,722 B2 discloses a through-the-wall imaging device with antenna elements for transmitting and receiving signals, adapted to see through a wall so as to image objects behind the wall, and such that it comprises a base with a carrier portion and a multitude of connected spaced-apart extensions. At least part of the antenna elements is mounted on the extension. The area between neighboring extensions is free of any material of the base, at least when the extensions are in an operating state.

### SUMMARY

An embodiment may have a UWB tag for determining a presence of a living object, wherein the UWB tag comprises at least one UWB frontend transceiver, and the UWB tag is configured to transmit several pulses and to receive several associated reflected channel-impulse responses and to subsequently evaluate the same with respect to a change in the received associated reflected channel-impulse responses, wherein determining the change in the associated reflected channel-impulse responses indicates the presence of the living object.

Another embodiment may have a method for determining a presence of a living object by using at least one UWB tag, the method comprising: arranging the at least one UWB tag at a non-living object; emitting several pulses by the at least one UWB tag comprising at least one UWB frontend transceiver; receiving several associated reflected channel-impulse responses; and evaluating the received several associated reflected channel-impulse responses with respect to a change in the received associated reflected channel-impulse responses, wherein determining the change in the associated reflected channel-impulse responses indicates the presence of the living object.

Another embodiment may have a multistatic radar system comprising several UWB tags according to the invention, to simultaneously detect several living objects and/or to represent a room with UWB.

Another embodiment may have a non-transitory digital storage medium having a computer program stored thereon to perform the method for determining a presence of a living object by using at least one UWB tag, the method comprising: arranging the at least one UWB tag at a non-living object; emitting several pulses by the at least one UWB tag comprising at least one UWB frontend transceiver; receiving several associated reflected channel-impulse responses; and evaluating the received several associated reflected channel-impulse responses with respect to a change in the received associated reflected channel-impulse responses, wherein determining the change in the associated reflected channel-impulse responses indicates the presence of the living object, when said computer program is run by a computer.

In order to avoid a scenario as described above, this invention proposes to attach a UWB tag to a visual partition, such as a door or a wall, etc. This tag is attached on the side of the special unit and signals to the special unit whether someone is located in the immediate vicinity behind the wall. Depending on whether the UWB tag signals that somebody is located behind the door or the wall, etc., the door may be possibly blown up, or another way may be used to enter the building so as to avoid injuries of living objects, such as hostages.

The proposed UWB tag for determining a presence of a living object includes at least one UWB frontend transceiver. The UWB tag is configured to transmit several pulses and to receive several associated reflected channel-impulse responses and to subsequently evaluate the received reflected channel-impulse responses with respect to a change in the received associated reflected channel-impulse responses, wherein determining the change in the associated reflected channel-impulse responses indicates the presence of the living object.

The UWB described may be used to attach the UWB tag at a door so as to detect whether somebody is located on the other side of the door and, if so, at which distance. This information may be used to decide whether the door is to be blown up or whether any other way is selected to open the door.

A further aspect of the present invention relates to a method for determining a presence of a living object by using at least one UWB tag described herein. The method includes arranging the at least one UWB tag at a non-living object, transmitting several pulses by the at least one UWB tag, wherein the UWB tag includes at least one UWB frontend transceiver. The method includes receiving several associated reflected channel-impulse responses; and evaluating the received several associated reflected channel-impulse responses with respect to a change in the received associated reflected channel-impulse responses, wherein determining the change in the associated reflected channel-impulse responses indicates the presence of the living object. Determining the change in the received reflected channel-impulse responses allows to conclude that a living object is present behind the visual partition.

A further aspect of the present invention concerns a multistatic radar system including several UWB tags described herein so as to simultaneously detect several living objects and/or to represent a space with UWB.

The method described herein may be implemented with the help of a computer program product and may be executed when the computer program product runs on a computer.

### BRIEF DESCRIPTION OF THE DRAWINGS

Embodiments of the present invention will be detailed subsequently referring to the appended drawings, in which:

FIG. 1 shows the prior art as to how hostages are freed in a critical situation;

FIG. 2 shows a situation in which the proposed UWB tag is used;

FIG. 3 schematically shows the function of the proposed UWB tag;

FIG. 4 schematically shows the structure of the proposed UWB tag;

FIG. 5 schematically shows the situation according to FIG. 2, wherein the proposed UWB tag is used, and wherein the UWB tag communicates with an external device;

FIG. 6 schematically shows a multistatic radar system;

FIG. 7 shows an evaluation result signal of a UWB tag;

FIG. 8 shows a flow diagram of a method for determining the presence of a living object by using at least one UWB tag;

FIG. 9 schematically shows a 2D determination of a target object, and

FIG. 10 shows a comparison of the measured phases with a UWB tag in two different linear movements.

### DETAILED DESCRIPTION OF THE INVENTION

The principle of the teaching disclosed herein is illustrated in more detail below with reference to possible embodiments, wherein the detailed description of individual embodiments does not constitute a limitation of the teaching described herein.

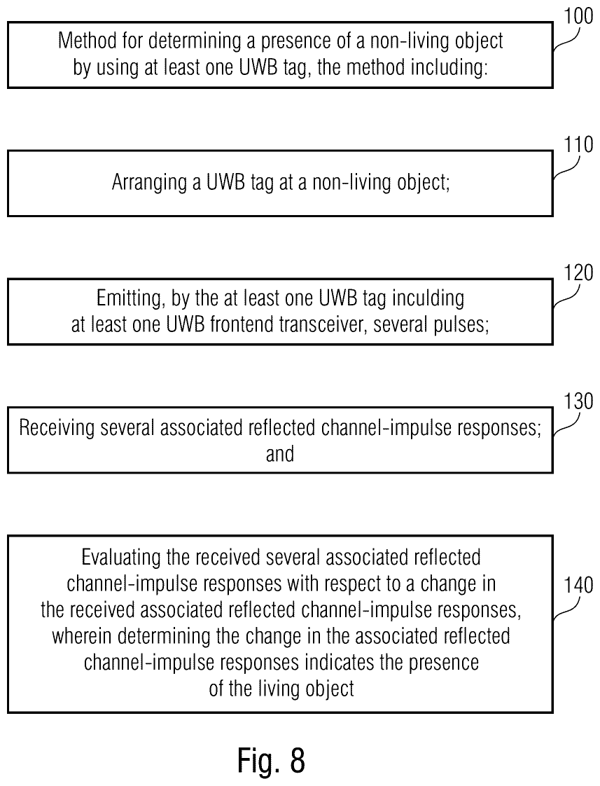

Individual aspects of the invention described herein are subsequently described in FIGS. 2 to 10. In the present application, the same reference numerals indicate the same elements or elements having the same effect, wherein not all of the reference numerals have to be mentioned in all drawings, if they repeat themselves.

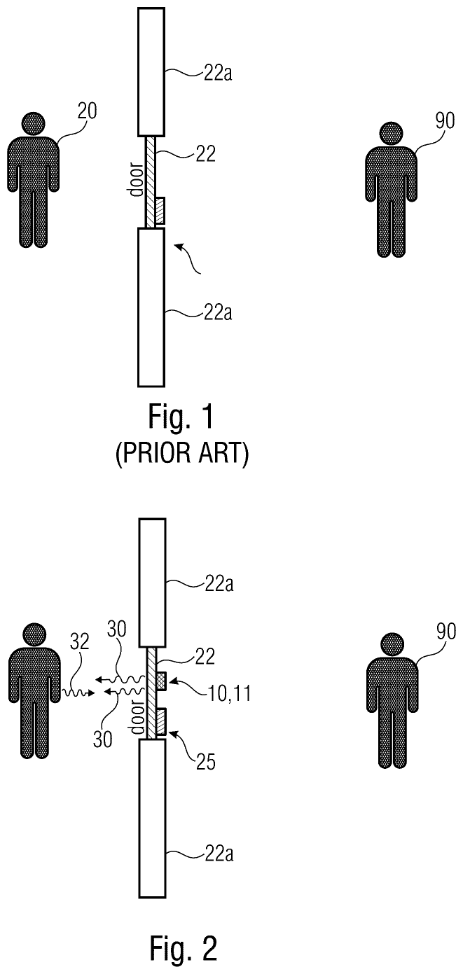

FIG. 1 schematically shows how hostages can be freed from a critical situation, and has already been described in detail in the introductory part of the description.

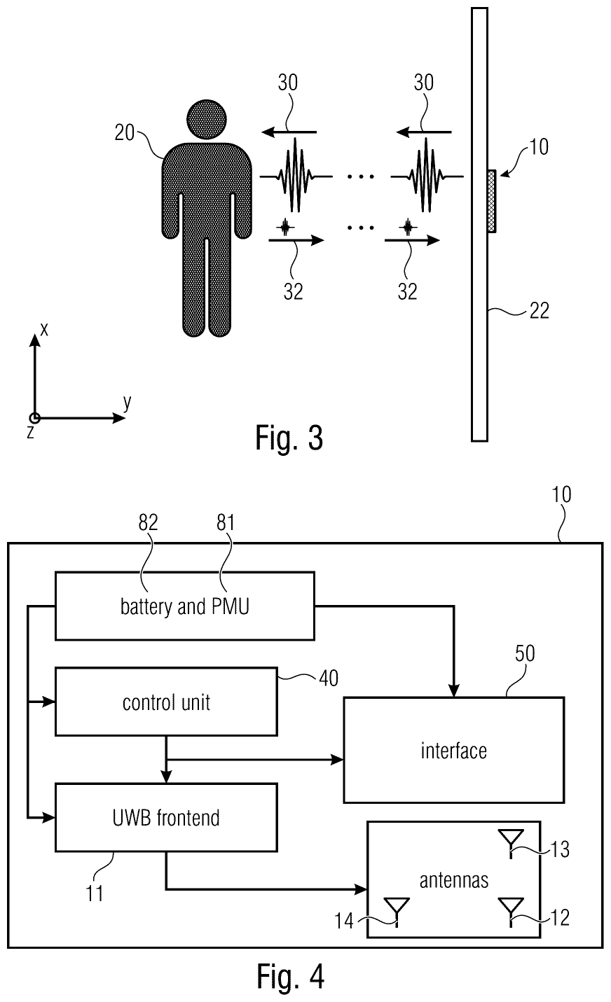

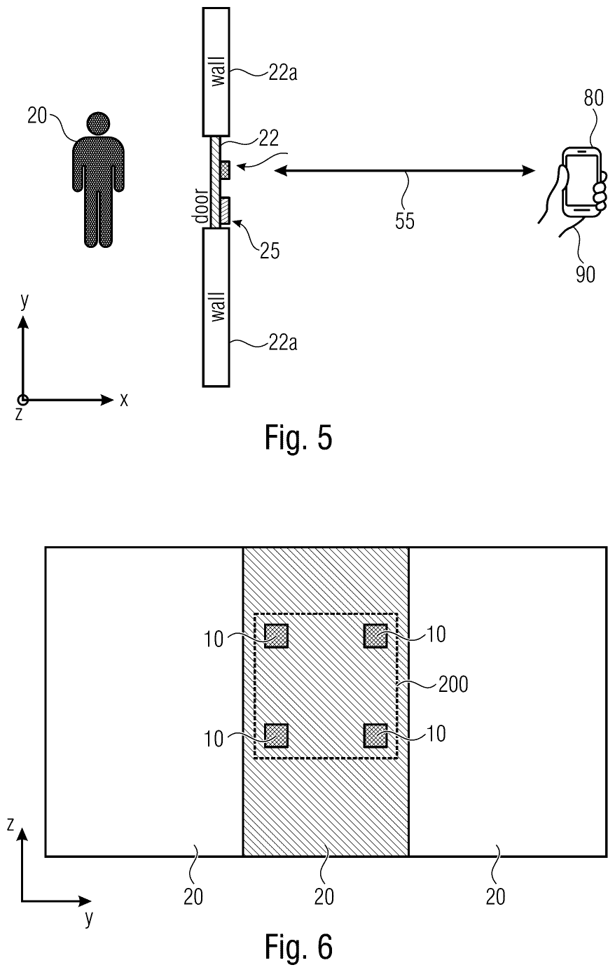

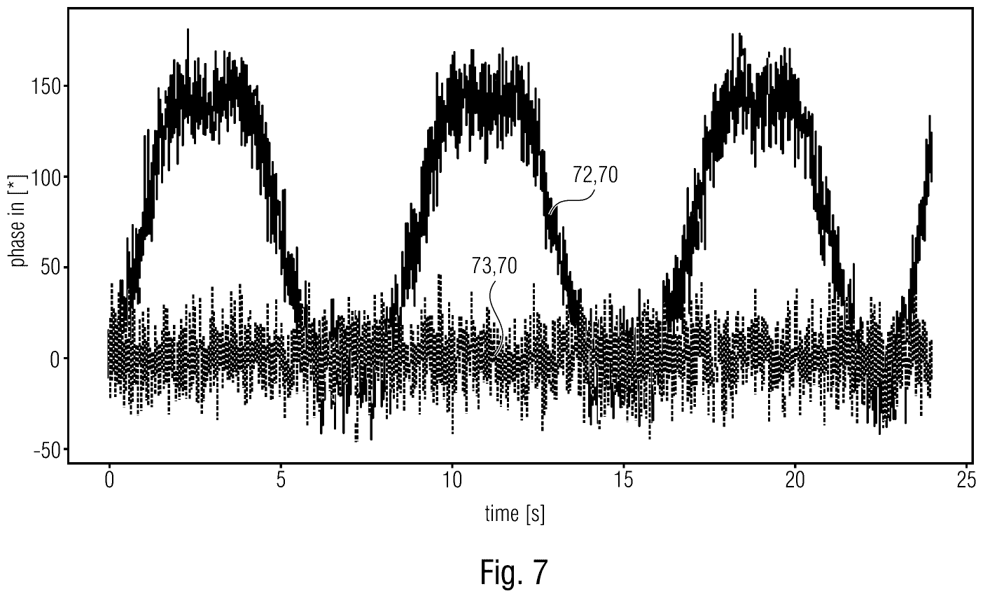

FIG. 2 shows a situation in which the proposed UWB tag 10 is used. FIG. 3 schematically shows the functionality of the UWB tag 10. FIG. 4 schematically shows the structure of a single UWB tag. FIG. 5 shows the UWB tag communicating with an external device 80. FIG. 6 shows a multistatic radar system including at least two UWB tags 10. FIG. 7 shows an evaluation result signal 70 of a single UWB tag 10. The proposed UWB tag is described in using a combination of FIGS. 2 to 7.

The proposed UWB tag 10 for determining a presence of a living object 20, as can be seen in FIGS. 2 to 5, includes at least one UWB frontend transceiver 11. The UWB tag 10 is configured to transmit several pulses 30 (as can be seen in FIG. 3) and receive several associated reflected channel-impulse responses 32, and to subsequently evaluate them with respect to a change in the received associated reflected channel-impulse responses 32, wherein determining the change in the associated reflected channel-impulse responses 32 indicates the presence of the living object 20.

The UWB frontend transceiver 11 is configured to periodically and/or non-periodically transmit the several pulses on one or several carrier frequencies. For example, the carrier frequencies in the UWB channels 5-9, i.e. with a carrier frequency between 6.5 and 8 GHZ, may be used. Depending on whether energy is to be saved, the carrier frequency of the measurements would be changed adaptively. In other words, there is a kind of wake-up mode in which pulses are transmitted less often and therefore less precisely, and a reflected channel-impulse response is measured less often and therefore less precisely. In the transition between the wake-up mode and the operating mode, the pulses would be transmitted more often since a more precise measurement is desired. The carrier frequency itself is periodical, only the measurement packet (i.e. the pulse chains=the transmitted pulses) are transmitted non-periodically, or with changing periods.

FIG. 2 shows the scenario of FIG. 1, with the difference that a UWB tag 10 is located at the door 22, i.e. the non-living object 22, that is to be blown up. This UWB tag 10 is located near an explosive charge 25. The UWB tag 10 transmits, in particular periodical, pulses 30 and receives the associated channel-impulse responses. These channel-impulse responses 32 may be used to detect movements behind the door 22. For example, a movement behind the door 22 is a respiration of a living object 20, such as a human being 22. In other words, a detectable movement does not necessarily have to be that of a hand, leg, or a movement of the entire body. A detectable movement may also be a small movement of the torso, as it is moved due to the human respiration or the heartbeat. Obviously, the significance whether something has moved or not depends on the size of the surface that has moved. However, the so-called radar effective cross-section of a breathing human body is usually enough to detect the breathing human being with the proposed UWB tag 10.

FIG. 3 schematically shows the functional principle of the UWB tag 10 in detail, using UWB radar technology. The UWB tag 10 emits a sequence of pulses 30 on one side of the door 22. This pulse sequence passes through the door 22 into the room, where it strikes a reflective surface, such as a human being 22, i.e. the living object 22, on the other side of the door 22. The signal reflected back from the human being 22, i.e. the channel-impulse response 32, propagates through the room towards the door 22 and passes through the same. The UWB tag 10 that receives the reflected pulses, i.e. the channel-impulse responses 32, and then processes them is located on the other side of the door 22.

The UWB frontend transceiver 11 is configured to transmit the pulses 30 so as to be convoluted with a correlation identification on the basis of which the associated reflected channel-impulse response responses 32 can be determined. In principle, a pulse is convoluted with a code sequence that has good correlation properties. In other words, instead of transmitting only a pulse, a sequence of positive and negative pulses having been convoluted with the code sequence is transmitted, for example. For example, Ipatov preambles have good correlation properties. They have an ideal auto-correlation, i.e. when correlating the preamble with itself, only one pulse is obtained as a correlation result. When correlating the preamble with other Ipatov preambles, a relatively weak correlation result is obtained.

As can be seen in FIG. 4, the UWB frontend transceiver 11 may include at least one transmission antenna 12 for emitting the several pulses 30 and at least two reception antennas 13, 14 for receiving the reflected channel-impulse responses 32. It is also possible that one antenna 12, 13, 14 is used as a reception antenna and transmission antenna. In other words, the at least one transmission antenna 12 for emitting the several pulses 30 and the at least one reception antenna 13, 14 may be given by a single antenna. In contrast to what is shown in FIG. 4, the UWB tag 10 could be configured with only one single antenna being used as a transmission and reception antenna. As shown in FIG. 4, the at least two reception antennas 13, 14 can be arranged so as to be spaced apart in the one UWB tag 10. If, e.g., at least two UWB tags are used, two reception antennas 13, 14 (one reception antenna 13, 14 per UWB tag 10) may be present, or at least four reception antennas 13, 14 (two reception antennas 13, 13 per UWB tag 10) may be present, wherein the reception antennas 13, 14 are arranged so as to be spaced apart. In addition, there are many more possibilities to place the reception antennas 13, 14 with respect to each other. The number of the antennas 12, 13, 14 and/or their positions may be changed arbitrarily.

The UWB tag 10 is configured to receive, depending on the number of reception antennas 13, 14, several, in particular different, channel-impulse responses 32, in particular in a sequential manner and/or simultaneously. Here, the number of the antennas may include only one antenna, serving as transmission and reception antenna. Or, the number of the antennas may include two or more antennas. In particular, TX antennas may be used. For a simultaneous reception, different preamble codes that differ, if possible, with respect to their correlation properties are required. For sequentially receiving the channel-impulse responses 32, the preambles do not have to differ, if there are no external devices that use the same preambles or would complicate the coexistence.

The UWB tag 10 includes a control unit 40 and a movement indication interface 50, wherein the control unit 40 is in communication connection with the UWB frontend transceiver 11 and with the movement indication interface 50 to obtain the received reflected channel-impulse responses 32 and to evaluate them with respect to the change and to subsequently transmit, after positive determination of the change, an evaluation result signal 72 to the movement indication interface 50, which is configured to inform a user about the presence of the living object 20. The communication connection between the control unit 40 and the movement indication interface 50 may be unidirectional. However, bidirectional communication is also conceivable. Advantageously, the communication connection between the control unit 40 and the UWB frontend transceiver 11 is bidirectional. The control unit 40 is configured to evaluate the received reflected channel-impulse responses 32 after reception. During evaluation, it may be determined whether the received reflected channel-impulse responses 32 show a change in the temporal course of their phase. The change is identified by a captured period (sine or cosine progression) in the determined phase. FIG. 7 exemplarily shows two evaluation result signals 70, 72, 73. The result signal 73 shows in the center a horizontal straight line at 0 degrees and corresponds to the evaluation result signal obtained if respiration of a living object 20 cannot be determined. If no movement such as respiration and/or heartbeat is detected, no period is captured by the channel-impulse response 32, but a straight line in the average temporal progression (cf. 73 in FIG. 7). The evaluation result signal 72 is a phase signal that changes periodically and indicates that a respiration of a living object 20 could be determined by means of the UWB tag 10. The evaluation result signal 72 shows a period. In other words, the respiration is detected by the phase/positional change in the period of the evaluation result signal 72 in FIG. 7. If the living object 20, such as a human being, would not breathe, there would be no period in the phase, as can be seen in the illustration of the evaluation result signal 73 in FIG. 7. Thus, the evaluation result signal 70 is shown without movement, such as respiration, as a horizontal straight line 73 in FIG. 7. The evaluation result signal 73 may be used to scan a room (or space) by means of UWB. In the evaluation result signal 70, 72 with a movement, in particular with a respiration, the period can be seen in the phase signal. The duration of the period depends on the respiration frequency. FIG. 7 exemplarily shows a period of 10 seconds, indicating a very slow respiration. The period duration would change with the respiration frequency. The sine curve 73 in FIG. 7 shows the chest of the breathing human lifting and lowering. Mathematically, a Fourier transform is used so as to search for a periodic movement. In general, it would be enough to detect any type of movement (such as a movement of the living object, etc.) which stands out from the noise. For example, it is possible to detect the upper body movement via the heartbeat if the living object holds his/her breath.

As shown in FIG. 4, the UWB tag 10 includes the energy control unit 81 (PMU), which is advantageously fed by batteries 82, since cables have disadvantages with respect to the flexibility and maximum distance when arranging the UWB tag 10 at a non-living object 22. The control unit 40 takes care of the device state and the drive of the UWB frontend transceiver 11. In addition, the control unit 40 also reads the channel-impulse responses 32 from the UWB frontend transceiver 11 and takes care of the evaluation of the channel-impulse responses 32. Changes in the channel-impulse response 32 are an indication for a movement. Such a movement in the channel-impulse response 32 may be detected with the help of a threshold value being exceeded, with said threshold value being determinable. The threshold value is a value that indicates how large the movement has to be, e.g., an amplitude of 1-2 cm in the channel-impulse response 32, to indicate respiration. However, this value is only an example and may advantageously be a different one depending on the application (e.g. detection of respiration and heartbeat). It is also conceivable that a signal representing the noise ratio solely determines the threshold value or influences the same in addition to the above-described possibilities. If the threshold value is exceeded, the movement indication interface 50 is instructed by the control unit 40 to signalize a movement. Depending on the system and implementation, the movement indication interface 50 may be configured in a relatively simple manner, e.g., by means of an LED, or may be rather complex and may transmit a signal to one or several external devices 80, so that they may create corresponding visualizations of the movement. For example, such a visualization may occur on a mobile device that is held by the special unit (cf. FIG. 5).

The movement indication interface 50 is configured to display the change directly at the UWB tag 11 and/or after transferring the evaluation result signal 70, 72, 73, displaying the change, to a least one external device 80 in an optical and/or acoustic manner to a user 90. The optical display of the detected change could be done by means of a light display (e.g. LED) in different colors. A green light could indicate the determination of the change, i.e. the respiration of a living object 20. A red light could indicate lack of the change, i.e. no respiration. Obviously, such color codes could vary arbitrarily. The acoustic indication of the captured change could be done by means of sound, e.g., i.e. by emitting a certain sound in a respective situation. The display of the change could also be carried out on an external, in particular mobile, device 80, such as on a mobile telephone or a smartphone.

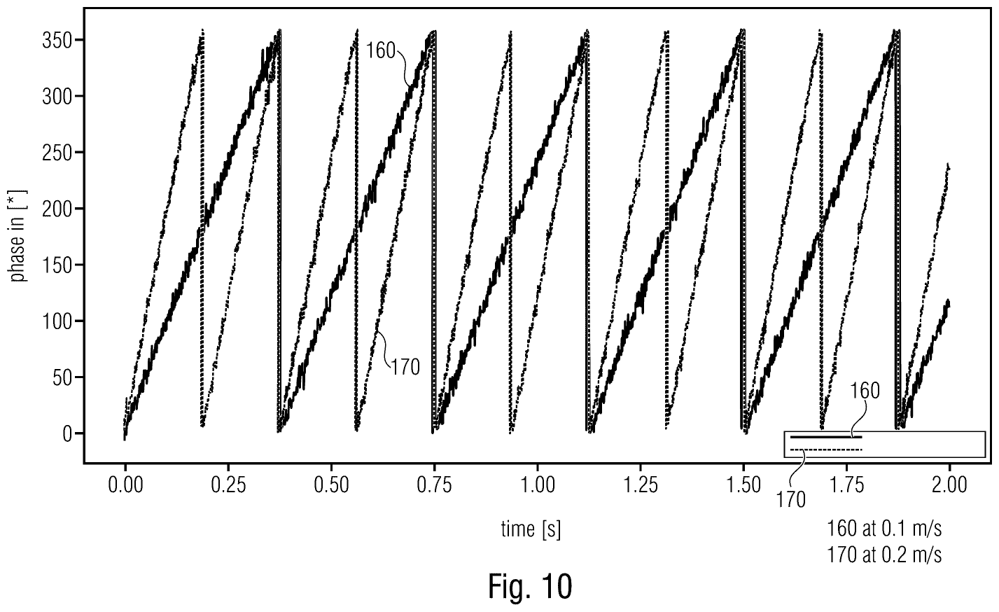

The evaluation result signal 70, 72, 73 includes information for generating a radar reply, such as scanning a room by means of UWB, and/or information about the type of a movement of the living object 20. In the present case, a radar reply is given by the associated channel-impulse response changing over time (cf. evaluation result signal 72 in FIG. 7). The temporal changes are shown on the basis of phase and amplitude changes in the channel-impulse response. As described with respect to FIG. 7, the respiration is detected by the phase/positional change of the peaks. Depending on the movement, the phase and the amplitude of the channel-impulse response will change differently. In case of a respiration, e.g., one can see a periodic change in the frequency of the respiration. In case of a linear movement, the movement speed is shown in the phase. FIG. 10 shows a comparison of the measured phases with a UWB tag 10 in case of a first linear movement 160 of 0.1 m/s and in case of a second linear movement of 0.2 m/s. The second linear movement 170 is twice as fast as the first linear movement 160. Consequently, the phase period of the second linear movement 170 is twice as fast as the phase period of the first linear movement 160.

The UWB tag 10 and the external device 80 are configured to communicate, in particular bidirectionally, via a data channel 55 such as UWB or WiFi or BLE. FIG. 5 illustrates the external device 80 as a smartphone, for example. The external device 80 could also be represented by an external mobile device such as a laptop or the like. The control unit 40 could be driven via the external device 80.

For example, the mobile external device 80 could display the detailed evaluated radar response, i.e. an evaluation result signal 70, 72 to 73, and could give more information about the type of the movement (cf. FIG. 5). For example, a radar reply could indicate a movement speed and/or a movement direction of a living object and/or the distance of the living object. The data channel 55 between the UWB tag 10 and the external device 80 may operate via UWB, however, other/different data channels 55, such as WiFi, BLE, . . . , would be good candidates, depending on the system implementation. The UWB frontend transceiver 11 itself may potentially emit the pulses 30 on one or several carrier frequencies.

When combining the channel-impulse responses of the carrier frequencies, the accuracy, i.e. the system power/system performance, can be improved. Combining the channel-impulse responses of the carrier frequencies is called channel stitching or band stitching. In this case, temporally-offset measurements on different channels are combined so as to obtain one measurement with a higher virtual bandwidth. Normally, UWB radar technology uses simple pulse transmissions without a special correlation identification (correlation code), however, the coexistence may be improved with the help of Ipatov preambles, defined in IEEE 802.15.4z/ab, which may lead to an improved system scalability. Whether correlation codes are used or not depends on the implementation of the UWB tag 10. Ipatov preambles are mathematical convolutional codes with ideal correlation properties and a relatively good isolation between the codes.

Advantageously, the UWB tag 10 is a single-use disposable product that would be destroyed in case of a possible explosion. If, as is shown in FIGS. 2 and 5, explosives 25 would be attached near the UWB tag 10 at a non-living object 22, such a door 22 or a wall 22a, and the non-living object 22 would be blown up after detecting the change, i.e. the respiration of a living object behind the non-living object 22, the UWB tag 10 would be destroyed in the explosion. The proposed UWB tag could have an adhesive at its rear side, so as to attach the UWB tag 10 at a non-living object 22. The UWB tag 10 is configured as a circuit board housed in a housing, in particular molded in.

A UWB tag 10 is advantageously attached to a non-living object 22 that does not have any full-front surfaces in the radiation direction. If non-living object 22 having attached thereto a UWB tag 10 includes too much metal, the emitted pulses can no longer transmit the non-living object.

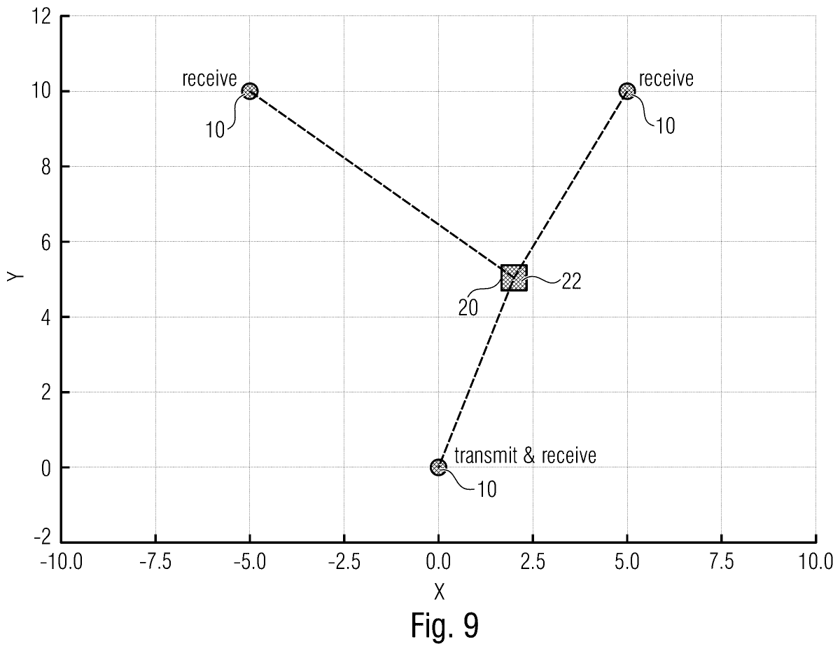

FIG. 6 shows a further aspect of the present invention. FIG. 6 shows a multistatic radar system 200. The proposed multistatic radar system includes several UWB tags 10 described herein so as to simultaneously detect several living objects 20 and/or to represent a room with UWB. A “representation of the room” means a representation of living objects 20 in the room. If a pulse is reflected from a non-living object 22, the reflected channel-impulse response does not have any phase shifts. If the different pulses of the multistatic radar system 200 are reflected at different living objects 20, the different changes captured may be used to represent the different positions of the living objects in a three-dimensional way. For example, FIG. 9 shows how a 2D position of a target may be determined in two dimensions. The two dimensions include an X and a Y coordinate. For example, a UWB tag 10 could be used for emitting several pulses and for receiving the channel-impulse responses 32 reflected from the objects 20, 22. In addition, further UWB tags 10 could be used only for receiving the same channel-impulse responses 32, wherein the further UWB tags 10 are arranged at different locations, i.e. spaced apart. In other words, only one UWB tag 10 emits pulses, while several UWB tags 10 detect the channel-impulse responses. The position of the target may then be determined in two dimensions (X, Y) from the captured channel-impulse responses.

For example, in FIG. 6, four UWB tags 10 are attached to a door 22, i.e. the non-living object 22. In other words, up to four living objects 20 could be captured by means of the multistatic radar system 200. In this case, it is to be noted that each UWB tag 10 scans a different spatial angle by means of UWB.

Advantageously, the several UWB tags 10 are arranged at least at one non-living object 22, in particular, wherein a non-living object 22 is a door 22 or a wall 22a or a substantially stabilized or upright device. The stabilized device could be a machine gun or the like. The UWB tag 10 can be placed directly at a stabilized device, such as a gun, resulting in the ability to detect movement in other rooms if the object is kept relatively steady.

Placement and number of the UWB tags 10 may vary from scenario to scenario. For example, to improve the system performance and the imaging performance, the multistatic radar system 200 may be implemented from several UWB tags 10 so as to simultaneously detect several living objects 20. FIG. 6 shows an example as to how several UWB tags 10 could be placed to create a type of X-ray image of the room with the help of the UWB technology. Placement and number of tags may vary depending on how many objects have to be detected simultaneously and how detailed the image of the room has to be.

The multistatic radar system 200 is configured to obtain a single channel-impulse response 32 per pair of UWB frontend transceivers 11, wherein the transmission antenna 12, TX, and the reception antenna 13, 14, RX, are separated in one of the two UWB frontend transceivers 11 or are separated in one and the same UWB frontend transceivers 11. In other words, a single pair of UWB frontend transceivers 11 may receive one channel-impulse response. The more pairs of UWB frontend transceivers 11 used, the more channel-impulse responses may be received. This achieves obtaining several signals, or several channel-impulse responses 32, resulting in an improvement of the accuracy of the radar response, or an image with respect to the radar response.

In other words, in a multistatic radar system 200, UWB tags 10 allow creating several channel-impulse responses 32. The multistatic radar system 200 may also be formed by UWB tags that each comprise only one TX/RX antenna. If only one TX/RX antenna is present in a UWB tag, this one TX-RX antenna emits pulses and receives the reflected channel-impulse responses 32. The following applies in this case: with N UWB-Tags 10, N*(N−1) channel-impulse responses 32 may be created, since each UWB tag pair may create one channel-impulse response 32, which allows creating a more detailed image of the constellation of room. In the equation above, N is actually the number of the TX/RX antennas, i.e. the more antennas a tag has, the more channel-impulse responses 32 may be created.

An advantage of the multistatic radar system 200 shown in FIG. 6 is that the multistatic radar system 200 typically improves the antenna insulation, since the antenna 12, 13, 14 of the several UWB tags 10 are further spatially separated from each other due to the arrangement of the UWB tags 10 which is why direct crosstalk can be suppressed better.

The multistatic radar system 200 described herein is configured to perform a method 100, as subsequently described.

FIG. 7 shows a further aspect of the present invention. FIG. 7 shows a flow diagram of a method 100 for determining a presence of a living object 20 by using at least one UWB tag 10.

The method 100 for determining a presence of a living object 20 by using at least one UWB tag 10 includes arranging 110 the at least one UWB tag 10 at a non-living object 22. The method 100 further includes emitting 120 several pulses 30 by the at least one UWB tag 10, which includes at least one UWB frontend transceiver 11. The method 100 further includes receiving 130 several associated reflected channel-impulse responses 32. Finally, the method 100 includes evaluating 140 the received several associated reflected channel-impulse responses 32 with respect to a change in the received associated reflected channel-impulse responses 32, wherein determining the change in the associated reflected channel-impulse responses 32 indicates the presence of the living object 20. The steps 110, 120, 130, 140 are to be carried out in an increasing order.

The method 100 may include periodic or non-periodic emission of the several pulses 30 on one or several carrier frequencies. In addition or as an alternative, the method may include transmitting each pulse 30 with a correlation identification (correlation code) on the basis of which the associated reflected channel-impulse responses 32 can be determined. As described in connection with the apparatus 10, it is possible to change from periodic emission to non-periodic emission or vice versa. Periodic or non-periodic emission advantageously takes place one after the other, i.e. sequentially.

The method 100 may include receiving, in particular sequentially and/or simultaneously, several channel-impulse responses 32, in particular originating from different transmitters 11.

After determining the change, the method 100 includes transferring an evaluation result signal 70, 72 to a movement indication interface 50 and/or to at least one external device 80 so as to inform about the presence of the living object 20, wherein the method 100 includes displaying the change directly at the UWB tag 10 and/or at the at least one external device 80. The method further includes transferring an evaluation result signal 70, 72 to a movement indication interface 50 and/or to at least one external device 80 so as to indicate that no living object 20 has been detected. Associated details were already described in connection with the UWB tag 10, with reference to this being made.

The method 100 further includes communication of the UWB tag 10 and the external device 80 via a data channel 55 such as UWB or WIFI or BLE.

According to an aspect, the UWB tag 10 described herein may be provided as a computer program product for performing a method 100 described herein when the computer program product runs on a computer.

Even though some aspects have been described in connection with a device, it is understood that these aspects also constitute a description of a corresponding method, so that a block or component of the device can also be understood as a corresponding method step or as a feature of a method step. For reasons of redundancy, a complete description of the present invention in the form of method features is omitted here.

In the preceding detailed description, different features have in some cases been grouped together in examples in order to rationalize the disclosure. This type of disclosure should not be interpreted as an intention that the claimed examples have more features than are expressly stated in each claim. Rather, as the following claims reflect, the subject-matter may be found in less than all the features of a single disclosed example. Consequently, the following claims are hereby included in the detailed description, each claim being able to stand as a separate example. While each claim can stand as a separate example, it should be noted that although dependent claims refer back to a specific combination with one or more other claims, other examples may also include a combination of dependent claims with the subject-matter of any other dependent claim or a combination of any feature with other dependent or independent claims. Such combinations are included unless it is stated that a specific combination is not intended. Furthermore, it is intended that a combination of features of a claim with any other independent claim is also included, even if that claim is not directly dependent on the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

1. https://jwcn-eurasipjournals.springeropen.com/articles/10.1186/1687-1499-2011-20
2. https://spyassociates.com/ultra-wideband-gpr-detector-to-see-through-walls-ground/
3. https://retwis.eu/
4. https://themedialine.org/life-lines/new-israeli-tech-that-can-see-through-walls-to-be-unveiled-at-paris-military-expo/

1. UWB tag for determining a presence of a living object, wherein the UWB tag comprises at least one UWB frontend transceiver, and the UWB tag is configured to transmit several pulses and to receive several associated reflected channel-impulse responses and to subsequently evaluate the same with respect to a change in the received associated reflected channel-impulse responses, wherein determining the change in the associated reflected channel-impulse responses indicates the presence of the living object.

2. UWB tag according to claim 1, wherein the UWB frontend transceiver is configured to periodically and/or non-periodically transmit the several pulses on one or several carrier frequencies.

3. UWB tag according to claim 1, wherein the UWB frontend transceiver is configured to transmit the pulses so as to be convoluted with a correlation identification on the basis of which the associated reflected channel-impulse response can be determined.

4. UWB tag according to claim 1, wherein the UWB frontend transceiver comprises at least one transmission antenna for emitting the several pulses and at least one reception antenna for receiving the reflected channel-impulse response.

5. UWB tag according to claim 4, wherein the UWB tag is configured to receive, depending on a number of the reception antennas, several channel-impulse responses, in particular sequentially and/or simultaneously, in particular originating from different transmitters.

6. UWB tag according to claim 1, wherein the UWB tag comprises a control unit and a movement indication interface, wherein the control unit is in communication connection with the UWB frontend transceiver and with the movement indication interface to acquire the received reflected channel-impulse responses and to evaluate the same with respect to the change and to subsequently, after positive determination of the change, transfer an evaluation result signal to the movement indication interface configured to inform about the presence of the living object.

7. UWB tag according to claim 6, wherein the movement indication interface is configured to display the change directly at the UWB tag and/or after transferring the evaluation result indicating the change to at least one external device, in an optical and/or acoustic manner to a user.

8. UWB tag according to claim 7, wherein the evaluation result signal comprises information for reproducing a radar response and/or information about the type of movement of the living object.

9. UWB tag according to claim 7, wherein the UWB tag and the external device are configured to communicate, in particular bidirectionally, via a data channel such as UWB or WiFi or BLE.

10. UWB tag according to claim 1, wherein the UWB tag comprises an energy control unit, PMU, wherein the energy control unit is configured to supply the UWB tag with energy via a battery.

11. UWB tag according to claim 1, wherein the UWB tag is a single-use disposable product.

12. Method for determining a presence of a living object by using at least one UWB tag, the method comprising:
arranging the at least one UWB tag at a non-living object;
emitting several pulses by the at least one UWB tag comprising at least one UWB frontend transceiver;
receiving several associated reflected channel-impulse responses; and
evaluating the received several associated reflected channel-impulse responses with respect to a change in the received associated reflected channel-impulse responses, wherein determining the change in the associated reflected channel-impulse responses indicates the presence of the living object.

13. Method according to claim 12, the method comprising:
periodically or non-periodically emitting the several pulses on one or several carrier frequencies; and/or
transmitting each pulse with a correlation identification on the basis of which the associated reflected channel-impulse response can be determined.

14. Method according to claim 12, the method comprising:
in particular sequentially and/or simultaneously, receiving several channel-impulse responses, in particular originating from different transmitters.

15. Method according to claim 12, the method comprising:
after determining the change, transferring an evaluation result signal to a movement indication interface and/or to at least one external device to inform about the presence of the living object, wherein the method comprises displaying the change directly at the UWB tag and/or at the at least one external device.

16. Method according to claim 15, the method comprising:
communicating the UWB tag and the external device via a data channel such as UWB or WiFi or BLE.

17. Multistatic radar system comprising several UWB tags according to claim 1, to simultaneously detect several living objects and/or to represent a room with UWB.

18. Multistatic radar system according to claim 17, wherein the several UWB tags are arranged at least at one non-living object, wherein, in particular, a non-living object is a door or a wall or an essentially stabilized or upright device.

19. Multistatic radar system according to claim 17, configured to acquire a single channel-impulse response per pair of UWB frontend transceivers, wherein the transmission antenna, TX, and the reception antenna, RX, are separated in one of the two UWB frontend transceivers each.

20. Multistatic radar system according to claim 17, wherein the multistatic radar system is configured to perform a method according to claim 12.

21. A non-transitory digital storage medium having a computer program stored thereon to perform the method for determining a presence of a living object by using at least one UWB tag, the method comprising:
arranging the at least one UWB tag at a non-living object;
emitting several pulses by the at least one UWB tag comprising at least one UWB frontend transceiver;
receiving several associated reflected channel-impulse responses; and
evaluating the received several associated reflected channel-impulse responses with respect to a change in the received associated reflected channel-impulse responses, wherein determining the change in the associated reflected channel-impulse responses indicates the presence of the living object,
when said computer program is run by a computer.
